(19) United States
(12) Patent Application Publication
(10) Pub. No.: US 2006/0136839 A1
(43) Pub. Date: Jun. 22, 2006

(54) Indicating related content outside a display area

(75) Inventor: Mikko Makela, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/021,484

(22) Filed: Dec. 22, 2004

(51) Int. Cl. G06F 17/00

(52) U.S. Cl. 715/786; 715/849; 715/850

(57) ABSTRACT

This invention relates to a method, a computer program, a computer program product, a device and a system for displaying portions of an object, wherein at least a first portion of an object is displayed, wherein it is decided if a second portion of said object, which second portion is not visible during said displaying of said first portion, is related to said first portion, and wherein an indication of said second portion is displayed, if it is decided that said second portion is related to said first portion. The invention may for instance be deployed to display enlarged portions of a web page on the display of a hand-held electronic device and to indicate if there are further portions of said web page which are related to the currently enlarged portion of said web page and are not visible due to the enlargement of the currently displayed portion.

### FIELD OF THE INVENTION

This invention relates to a method, a computer program, a computer program product, a device and a system for displaying portions of an object.

### BACKGROUND OF THE INVENTION

The ongoing miniaturization of multi-media devices such as Personal Digital Assistants (PDAs) or mobile phones in recent years appears to be only bounded by the perceptual limits of the human viewer. This particularly applies to the design of the displays of multimedia devices, with a remarkable trend to increase the relative area of the device that is consumed by its display. However, the display sizes of, for example, hand-held devices are necessarily significantly smaller than the display sizes, for which content is usually designed. If for instance content of the World Wide Web (WWW), i.e. web pages formatted according to the Hypertext Markup Language (HTML) or derivatives thereof (such as Extensible HTML (XHTML)), is to be displayed on the display of a hand-held device, it has to be considered that these web pages normally have an original presentation size designed for portrayal on a computer monitor, the dimensions of which are often remarkably larger than the display dimensions of a hand-held device such as a mobile phone.

Viewing web pages on a small display requires horizontal and vertical scrolling with scroll bars, which is generally experienced as uncomfortable or even annoying for the viewer.

Consequently, most browsers that are installed in, for example, hand-held devices and provide for the interpretation of the web page content offer the possibility to view web pages in a format that is optimized for the display dimensions of the hand-held device. This is usually achieved by at least partially scaling and/or rendering the web page so that it fits the width of the device's display.

The method of rendering the page so that it fits the width of the device's display causes a couple of problems. Rendered pages get very tall, so a lot of vertical scrolling is required. Furthermore, the structure of the web page is not preserved well by the rendering process, for example form elements like input fields frequently get separated far away from each other if they are aligned using tables. Finally, not all elements of a web page may lend themselves to rendering to the display width, and then may be maintained as they are, as it may for instance be the case for image maps that contain navigation elements or horizontally extending banners.

To alleviate these problems, most browsers additionally offer an original layout viewing method, as all the pages just do not convert usably into tall and narrow format.

In an alternative approach, it has been proposed to divide a web page into a plurality of sub-objects, and to display said plurality of sub-objects in a small representation so that an overview can be gained over the structure of the web page. Said sub-objects are made selectable, and upon selection by viewer interaction, at least a selected sub-object then is displayed in a larger representation that allows for the inspection of details of said sub-object. It is then possible to switch back to the smaller representation of all sub-objects again, or to scroll from one sub-object to adjacent sub-objects in said large representation.

Regardless which of the above-described techniques for presenting large web pages on small displays is deployed (complete or partial rendering of a page, original layout mode, or enlarged presentation of sub-objects of a page), the common problem arises that when only a portion of a web page is displayed, coherent content of said web page may be cut, and when inspecting the content of the portion of the web page presented to a viewer, he may get the impression that this content is complete, although there is related, but cut-off content in adjacent portions of said web page that are currently not visible.

An example for this phenomenon is now presented with reference to FIGS. 1-3.

FIG. 1 illustrates a web page 1 in its original presentation size, which may for instance be displayed on a PC monitor. The web page contains text elements 2 and 5, an image 4, and hyperlinks 3-1, 3-2 and 3-3.

FIG. 2 illustrates the web page 1a which is obtained from the web page 1 of FIG. 1 by partial rendering and scaling. As can be seen, the text element 2a, the image 4a and the hyperlinks 3a-1, 3a-2 and 3a-3 in FIG. 2 have been scaled to a smaller size with respect to their counterparts in FIG. 1, and the text element 5a has been scaled and rendered to a tall structure, for instance to match the display width of a hand-held device. The web page 1a in FIG. 2 then can be considered as a representation of the web page 1 of FIG. 1 in original layout mode, as the basic layout of the web page 1 is maintained in web page 1a, and only minor modifications have been performed to allow for a more convenient displaying of this web page 1a on the display of a hand-held device.

FIG. 3 shows a portion 1b of the web page 1a of FIG. 2, displayed on the display of a hand-held device. Due to the limited display dimensions of said hand-held device, only said text element 2a,an image 4b, which is a vertically cut portion of image 4a, an a text element 5b, which is a horizontally cut version of text element 5a, can be presented on said display. In effect, FIG. 3 thus illustrates the left upper portion 1b of web page 1a that is visible when web page 1a is viewed on the hand-held display in original layout mode. Optionally, a vertical and/or horizontal scroll bar may appear at appropriate borders of said display to allow a viewer to scroll to the right and to the bottom of web page 1a.

When comparing the web page 1a of FIG. 2 and the portion 1b of FIG. 3, it is readily seen that, when viewing said portion 1b, and apart from the cut image 4b, the content in said portion 1b appears to be complete at least in horizontal direction, as the text element 5a has been rendered to fit the display of the hand-held device. A viewer thus expects the text in text element 5b to continue at the bottom of the portion 1b, and thus is motivated to explore the rest of the text by scrolling down. However, as the content appears to be complete in horizontal direction, and only the image 4b appears to be cut, the viewer, if not particularly interested in the complete image, will most likely not take notice of the hyperlinks 3a-1, 3a-2 and 3a-3 that are visible in the web page 1a of FIG. 2, but not in the portion 1b of the web page in FIG. 3.

### SUMMARY OF THE INVENTION

In view of the above-mentioned problems, the present invention proposes an improved method, computer program, computer program product, device and system for displaying portions of an object.

Proposed is a method for displaying portions of an object, said method comprising displaying at least a first portion of an object; deciding if a second portion of said object, which second portion is not visible during said displaying of said first portion, is related to said first portion; and displaying an indication of said second portion, if it is decided that said second portion is related to said first portion.

Said object may be any two-dimensional (2D) or three-dimensional (3D) object that lends itself for portrayal via a display unit, as for instance a cathode ray tube, all types of liquid crystal or organic light emitting diode displays or image or video projection systems. Said objects thus may for instance be web pages specified in a markup language as for instance the Hypertext Markup Language (HTML) or the extensible Hypertext Markup Language (XHTML), pages of a text document, slides of a presentation, three-dimensional objects such as for instance structures defined by the Virtual Reality Markup Language (VRML), representations of data in the context of application views, wherein representations of data of an application are displayed instead of said data itself, as for instance a grid of thumbnails that represent image data, a folder structure that represents a file system, or calendar sheets that represent time schedules of days in a calendar application, or similar types or objects that lend themselves for displaying. Said object may have been processed to allow for an improved portrayal, for instance, if said object is a web page, it may have been at least partially rendered to fit a dimension of a display.

At least a first portion of said object is displayed, for instance due to the fact that said object may be too large to be completely displayed. When said first portion is displayed, other portions of said object may not be visible. Furthermore, said first portion may have been processed before said displaying, for instance to fit a dimension of a display. Said processing may for instance comprise scaling and/or rendering.

Before, during or after said displaying of said first portion, it is decided if a second portion of said object is related to said first portion. Said relation between said first and second portion may for instance refer to the arrangement of both portions in said object, for instance, said two portions may be at the same horizontal or vertical position; or to the embedding of both portions into the structure of said object, for instance, said two portions may belong to the same table cell or column or row of a table structure; or to the content of both portions.

Said second portion is not visible during said displaying of said first portion, so that a viewer of said first portion may not have a chance to recognize that the first and second portion are related.

If it is decided that said second portion is related to said first portion, an indication of said second portion is displayed. This notifies a viewer that there is related content outside the portion of the object he is currently viewing. Said indication may for instance be an arrow pointing towards a direction of said second portion with respect to said first portion

It may well be possible that it is decided that several second portions of said object are related to said first portion, and then, one common indication of said second portions or single indications for each of said second portions may be displayed, respectively.

Thus according to the present invention, it is determined if there exists a currently not visible portion of an object, which portion is related to that portion of an object that is currently displayed, and if this is the case, the viewer is notified of this related portion via a displayed indication. This approach overcomes the prior art situation in which portions of an object are not recognized because the currently displayed portion appears to be complete. The method of the present invention is easily implemented, and, depending on the type of indication used, for instance via a semi-transparent arrow, does not affect the portrayal of said first portion of said object.

According to an embodiment of the present invention, a direction from said first portion to said second portion is displayed as said indication of said second portion.

Then a viewer is not only notified of said second portion that is related to said first portion, but also obtains information in which direction he has to scroll to see the related second portion of said object. This also holds for the case where it is decided that several second portions of said object are related to said first portion, and corresponding directions are displayed. Said direction may for instance be displayed as an arrow, but equally well, all other signs, symbols or techniques suited to express a direction may be deployed, for instance a right border of said first portion may be displayed colored or faded out if said second portion is located rightward to said first portion. Furthermore, in addition to said direction, a distance from said first portion to said second portion may be indicated. Equally well, a distance to said second portion from the edge of the display that is closest to it may be indicated.

According to an embodiment of the present invention, said direction is substantially a horizontal direction. Said first and second object then may for instance be related in a way that they are substantially at the same horizontal position. This situation is for instance encountered if an object is rendered to fit the width of a display and some portions of said object can not be rendered to said width of said display. A viewer then gets used to this type of rendering and no longer expects content to be positioned at the left or right of the first portion that is displayed on the display. This situation may also occur if objects are viewed in an original layout mode with partial rendering of portions of said object to a display width, for instance fitting text passages of said object to the display width, wherein from the rendered text, a viewer may get an impression that the first portion of said object which he is currently viewing is complete, although there is further content at the left or right of said first portion. This situation may further occur when an object is first displayed on a small scale, and then, upon selection by the viewer, one portion of said object is displayed enlarged. If said enlarged portion is rendered to fit the width of the display, the viewer may get the impression that the content in this enlarged portion is complete, and does not consider to explore the portions of said object located at the same horizontal position as said enlarged portion.

According to an embodiment of the present invention said object is a three-dimensional object, and said direction is a direction in a three-dimensional space. Then said direction may be a horizontal direction, a vertical direction or a depth direction or any combination of these directions, for instance a direction lying in a plane spanned by the horizontal and the depth direction.

If said object is a three-dimensional (3D) object, as for instance a 3D map of a town or a building defined in the Virtual Reality Markup Language (VRML) or any other 3D object format, 3D portions of said 3D object in the foreground may obscure 3D portions behind them, and thus indicating these “hidden” 3D portions is particularly advantageous. Therein, said depth dimension is understood as the dimension in a 3D coordinate system that is perpendicular to both the horizontal and vertical dimension.

According to an embodiment of the present invention, said direction is represented by a separate graphical indicator. This may for instance be an arrow or a similar sign. This arrow may be located at the border of a display, or at the center, or at any other position. It may for instance be semi-transparent in order not to cover the first portion that is displayed, or be covering.

According to an embodiment of the present invention, said direction is indicated by altering the appearance of said first portion. This altering of said first portion may for instance be achieved by making said first portion look incomplete during its displaying. For instance, if said first portion is a text, and if there is a second portion outside of the display area on the right that is related to said first portion because it contains the continuation of the text in the first portion, three dots (“. . .”) can be added to the end of the visible text in the first portion. At least in western cultures, this is a common way of indicating incompleteness of a text.

If said first portion is an image or a part thereof, and if there is a second portion outside of the display area on the right that contains content related to said image, for instance a further part of said image, a small portion on the right edge of the image in said first portion can be shown with a fade-out effect that suggests to the user that the view is not complete.

According to an embodiment of the present invention, said indication contains information of said second portion. Said information may for instance be textual information on said second portion like a name or a description of the second portion, or image information, like a miniature picture of said second portion, or any other kind of information.

According to an embodiment of the present invention, said indication contains information about a distance to said second portion. Said distance may for instance be a distance from said first portion to said second portion, for instance taken from the center or an edge of said first portion to a center or an edge of said second portion. Equally well, said distance may be taken from the edge of the display that is closest to said second portion. Said distance my be indicated in a unit that relates to the dimensions of the display, for instance to indicate that the second portion is three display widths away, or relative to a dimension of said object, or in an absolute unit as for instance inches or pixels, or in any other way. Said distance information may be comprises in said indication, for instance, if said indication is an arrow, the length of said arrow may indicate said distance, or the number of displayed arrows may indicate said distance, or a value displayed close to said area may indicate said distance.

According to an embodiment of the present invention, said indication is only displayed for a limited duration of time. Said indication thus does not necessarily have to be visible continuously, it can also be hidden, for instance after the view has stayed on a same position for a certain time. This may be particularly convenient for users that prefer the original appearance of the content with minimum amount and duration of disturbance.

According to an embodiment of the present invention, said method further comprises dividing said object into a plurality of portions of said object; determining which of said portions is said first portion that is displayed; and determining said direction from said first portion towards said second portion.

Said division of said object into said plurality of portions does not necessarily have to be visible to a viewer, it may only be performed to determine which portion out of said plurality of portions is said first portion and to determine said direction from said first portion to said second portion. Furthermore, said division may serve as a basis for the definition of potential second portions that then may be investigated with respect to their relation to said first portion.

Even further, said process of dividing said object into said plurality of portions itself may be exploited to determine which portions of said object are related to each other, for instance, if a structure in said object has to be broken or cut in said process of dividing, the obtained portions may be considered as related portions.

According to an embodiment of the present invention, a sectioning algorithm is used to divide said object into said plurality of portions of said object. Said sectioning algorithm may for instance process said complete object and aim at a generation of a canvass of rectangular portions that resembles said object as much as possible, wherein parameters such as a minimum and/or maximum information and/or size threshold for said portions may be considered in said sectioning algorithm.

According to an embodiment of the present invention, said method further comprises deciding if said second portion contains relevant content, wherein said indication of said second portion is only displayed if a first condition, that said second portion is related to said first portion, and a second condition, that said second portion contains relevant content, are both true.

Second portions are then only indicated if they are related to said first portion and contain relevant content, so that they are worth being explored by a viewer. For instance, empty table cells or portions with an information content and/or size that is below respective threshold may be considered as irrelevant and may not be indicated.

According to an embodiment of the present invention, said second portion is considered to contain relevant content in dependence on its size and/or the type and/or amount of its content. With respect to size, portions with dimensions in inches or pixels being smaller than a threshold value may not be considered relevant. With respect to the content type, commercials may for instance not be considered relevant. With respect to the amount of content, portions that only contain a few pixels of image information or only a couple of letters may not be considered relevant. Parameters defining if a second portion is considered to contain relevant content may be set by a viewer according to this own preferences.

According to an embodiment of the present invention, said step of deciding if said second portion of said object is related to said first portion is based on relations of portions of said object that have been defined by a creator of said object. For instance, if said object is a web page, an author of said web page may have defined relations between portions of said web page, for instance relations between sections of said web page or similar structural components thereof. While authors do not generally define such relations on today's web pages, there arise upcoming topics like semantic web (probably standardized in the future by W3C), and it is envisaged that these future standards also bring ways to define relations between different parts of web pages and documents.

According to an embodiment of the present invention, said first portion is displayed in a presentation mode in which said object has been at least partially rendered. Said object then may for instance have been rendered to fit the width of a display to the best possible extent, and said displayed first portion then represents a part of said rendered object. For example, said indication then may advantageously notify a viewer of second portions of said object that could not be properly rendered to fit the display width and thus are located to the left or the right of said displayed first portion.

According to an embodiment of the present invention, said first portion is displayed in a presentation mode in which an original layout of said object has at least partially been preserved. For instance, said object may only have been scaled to a smaller size without substantially affecting the relative positions of structures in said object to each other. However, some optimizations like wrapping text to the display width and/or zooming in or out may have been performed in said presentation mode, which then nevertheless is understood as a presentation mode in which an original layout of said object has at least partially been preserved. Said first and second portions then represent respective parts of said rendered object.

If said first portion is displayed in said presentation mode in which an original layout of said object has at least partially been preserved, and is larger than the display area, only content of said first portion may be considered when investigating which content is related to said first portion. In other words, said second portion then is a portion of said first portion, and said second portion is searched in the area of the first portion that is currently not visible due to the fact that the first portion is larger than the display area.

According to an embodiment of the present invention, said object can be displayed in a first presentation mode, upon viewer interaction, at least said first portion is displayed in a second presentation mode, and a size of said first portion in said second presentation mode is substantially larger than its size in said first presentation mode. In this embodiment, an object is first divided into a plurality of portions. This plurality of portions may then be jointly displayed to give an overview on the structure of said object. Upon selection of single portions of said plurality of portions, said selected portion, i.e. said first portion, then may be displayed in a larger scale, wherein said non-selected portions may either be displayed jointly with said enlarged first portion or may no longer be displayed.

Due to said displaying of said first portion in a larger scale, portions of said object that are related to said first portion, for instance neighboring portions or portions at the same vertical or horizontal position, may no longer be visible, and it is advantageous to display an indication of such related portions to notify a viewer of said related portions. This avoids overseeing the content of related portions. The decision on which portions are related to said first portion may then be based on the division of said object into said plurality of portions. The decision on which portions are related may be made for all portions of said object during the process of dividing said object into said plurality of objects, or only for the first portion after its selection.

Related content may also be inside the enlarged first portion itself, for instance if said first portion happens to be larger than the display. In this case, for instance, every component of said first portion, for instance an image, link, etc. that is horizontally or vertically at the same level as the presently visible part of the first portion, but is presently not visible, may be considered as related. Thus said second portion that is related to said first portion is a part of said first portion itself.

There might also exist a situation when more than one portions are displayed in said second presentation mode (e.g., in an enlarged representation) while at the same time, one or more other portions are shown in said first presentation mode (e.g., in a small representation). In this case, content of some, for instance the closest, or all portions in said second presentation mode are considered when determining the related content, and content of some or all portions shown in said first presentation mode may be ignored.

According to an embodiment of the present invention, said first portion is displayed on a display of a hand-held electronic device. Said display may for instance be a liquid crystal or organic light emitting diode display, and said hand-held display may for instance be a lap-top computer, a mobile phone, a navigation system receiver, a personal digital assistant or any other kind of portable multimedia device.

According to an embodiment of the present invention, said object is a two-dimensional object. Said object may for instance be a web page, a page of a text document, a slide of a presentation, an image, a video or any other two-dimensional object suited for portrayal.

According to an embodiment of the present invention, said object has a page structure. Said object may for instance be a web page defined in HTML or XHTML, or a page of any kind of text document.

According to an embodiment of the present invention, said object is a three-dimensional object. Said object may for instance be defined by VRML, as for instance a three-dimensional map of a country, landscape, town, building, or room, or a three-dimensional view of an item or device.

Further proposed is a computer program with instructions operable to cause a processor to perform the above-mentioned method steps. Said processor may for instance be a display controller or a central processing unit of a device that is capable of displaying portions of said object.

Further proposed is a computer program product comprising a computer program with instructions operable to cause a processor to perform the above-mentioned method steps. Said computer program product may for instance be an electronic storage medium as for instance a memory card or stick, a read-only or random access memory, a removable electronic storage medium such as a CD, DVD or disc, or any other kind of electronic storage medium.

Further proposed is a device for displaying portions of an object, said device comprising means arranged for displaying at least a first portion of an object; means arranged for deciding if a second portion of said object, which second portion is not visible during said displaying of said first portion, is related to said first portion; and means arranged for displaying an indication of said second portion in dependence on said decision if said second portion is related to said first portion.

Said device may for instance be a hand-held electronic device as for instance a lap-top computer, a mobile phone, a navigation system receiver or a personal digital assistant.

Further proposed is a system for displaying portions of an object, said system comprising a first device and a second device, wherein said first device comprises means arranged for displaying at least a first portion of an object; wherein said second device comprises means arranged for deciding if a second portion of said object, which second portion is not visible during said displaying of said first portion, is related to said first portion; and wherein said first device further comprises means arranged for displaying an indication of said second portion in dependence on said decision if said second portion is related to said first portion.

Said first device may for instance be a hand-held electronic device as for instance a mobile phone, and said second device may for instance be a network element in a core system of mobile radio communications system.

These and other aspects of the invention will be apparent from and elucidated with reference to the embodiments described hereinafter.

### BRIEF DESCRIPTION OF THE FIGURES

In the figures show:

FIG. 1: A web page in its original presentation size according to the prior art;

FIG. 2: a partially rendered web page in original layout mode according to the prior art;

FIG. 3: a portion of the web page of FIG. 2 displayed on the display of a hand-held electronic device according to the prior art;

FIG. 4: a portion of the web page of FIG. 2 displayed on the display of a hand-held electronic device with an indication of relevant content outside the display area according to the present invention;

FIG. 5: a flowchart of a sectioning algorithm for dividing an object into a plurality of portions according to the present invention;

FIG. 6: a system according to an embodiment of the present invention; and

FIG. 7: a flowchart according to an embodiment of the present invention.

### DETAILED DESCRIPTION OF THE INVENTION

The present invention proposes to display an indication that, when displaying a first portion of an object, there exists a second portion of said object which portion is related to said first portion of said object and which portion is currently not visible. In the following detailed description, exemplarily the case of displaying said object on a display of a hand-held device will be considered. It should however be noted that the present invention also can be deployed in the context of displaying portions of objects on television or computer screens, displaying portions of objects via projection systems such as video beamers or displaying portions of objects via any other displaying device. Furthermore, the present invention is not limited to the context of displaying of portions of two-dimensional objects, such as web pages. Equally well, portions of three-dimensional objects that are currently not visible may be indicated to a viewer in the context of a three-dimensional application.

It should further be noted that the subject-matter of the introductory part of this patent application may be used to support this detailed description.

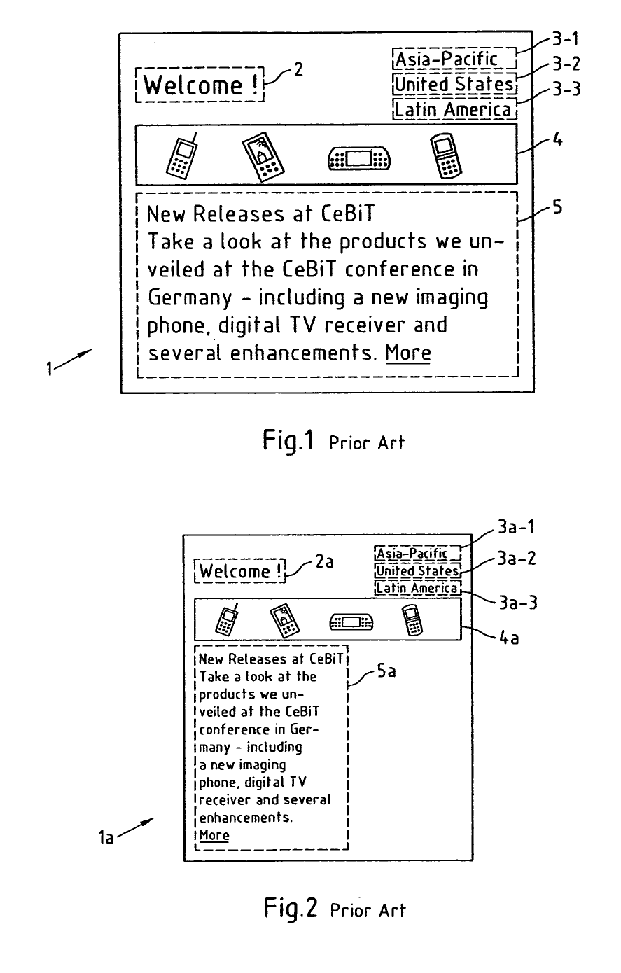

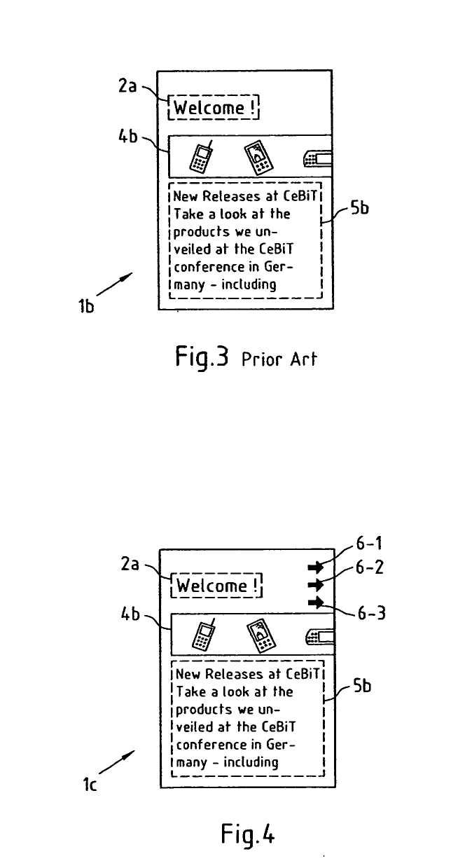

FIG. 4 shows a first portion 1c of the web page 1a of FIG. 2, displayed on the display of a hand-held device according to an embodiment of the present invention. As in FIG. 3, which represents the prior art, due to the limited display dimensions of said hand-held device, only the text element 2a, the image 4b, which is a vertically cut portion of image 4a, and the text element 5b, which is a horizontally cut version of text element 5a, can be presented on said display, wherein said text element 2a, the image 4a and the text element 5a stem from the web page 1a in FIG. 2 which is obtained from web page 1 of FIG. 1 by partial rendering and scaling. In effect, FIG. 4 thus illustrates the upper left portion 1c of web page 1a of FIG. 2 that is visible when web page 1a is viewed on the hand-held display in original layout mode.

However, in contrast to FIG. 3, when displaying the portion 1c of the web page according to FIG. 4, furthermore three arrows 6-1, 6-2 and 6-3 are displayed, which indicate to the viewer that there is a second portion outside the presently displayed first portion 1c of the web page 1a, which second portion is related to said first portion. In the present example, this second portion of the web page 1a is represented by the hyperlinks 3a-1, 3a-2 and 3a-3, which are related to said first portion 1c with respect to their positioning on the web page 1a: both the first portion 1c and the second portion, represented by hyperlinks 3a-1, 3a-2 and 3a-3, are horizontally positioned side by side.

Thus in the present example, the relationship between the first portion and the second portion of web page 1a is defined in terms of the positioning of said first and second portions in web page 1a, to account for the fact that, due to the displaying of said web page 1a in original layout mode, and due to the partial rendering of portions of said web page 1a to fit the width of the display of the hand-held device, portions at the left or right of such partially rendered portions are easily overseen. This may even happen for second portions at the left or right of first portions that are not specifically rendered, but that, due to the original layout mode, cause an impression that they represent the only relevant content at this height of web page 1a.

Equally well, the arrows 6-1, 6-2 and 6-3 may be used in an alternative embodiment of the present invention, where instead of the original layout mode of the web page 1 (as depicted in FIG. 2), a presentation mode in which said web page 1 is attempted to be completely rendered to fit the display width is used, and wherein only some specific portions of said web page can not be rendered to fit the display width. To indicate to a viewer that there exist portions at the left and/or the right of the presently displayed first portion, then again arrows or other means of indication may be deployed.

In a further embodiment of the present invention, the web page 1a is first divided into a plurality of portions, which are displayed on the display in a small scale, and then, when one of said portions is selected by a viewer, said selected (first) portion is displayed enlarged. Then, similarly, arrows may be displayed together with the enlarged first portion of the web page to indicate to a viewer that there is more related content, in particular if, during said division of said web page into said plurality of portions, structures of said web page have been cut, and if this cutting is not clearly visible from the single portions obtained from this cutting.

When deciding which second portions of said web page la are related to the currently displayed first portion, it may further be considered if said second portions contain relevant content or not. For instance, if there is an empty table cell located at the right of a first portion that is currently displayed, it may be decided that this empty table cell represents a related second portion, but that it does not contain relevant content. Then no indication of said second content is displayed.

According to the present invention, the direction and distance from said first to said second portion may be indicated to said viewer, for instance by using a double arrow for large distances and a single arrow for smaller distances.

It is not necessarily required to use arrows to indicate the direction between said first and second portion. Equally well, in FIG. 4, other symbols or indications instead of the arrows 6-1, 6-2 and 6-3 may be deployed, for instance there may be an indication at the right upper edge of the display, like a red bar or similar indications. To cover as little content of said first portion as possible, said arrows or indications may advantageously be semi-transparent or accordingly positioned, or may vanish after some time duration. Said arrows and indications may also appear outside said display, for instance as an illumination on the keypad of the hand-held device or similar.

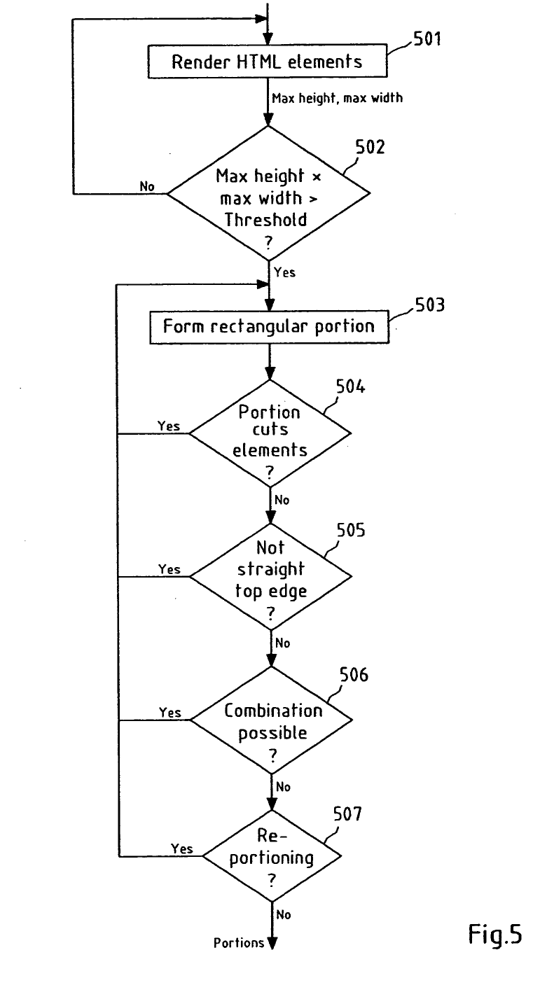

According to the present invention, the direction information that is indicated to a viewer may for instance be determined by dividing said web page 1a into a plurality of portions, to detect which of said portions (the first portion), is currently displayed, and then to determine the direction to the second portion that is considered to be related to the first portion. Said division of said web page into said plurality of portions may for instance be accomplished by a sectioning algorithm, as will be discussed with reference to FIG. 5 below. Said dividing of said web page may not be apparent to a viewer. However, in the embodiment that allows for a selection of portions of said web page in small scale in order to display the selected portion in larger scale, the same division of the web page that is used to offer the possibility to select and enlarge portions of the web page may also be used to determine the direction from said first to said second portion.

FIG. 5 depicts an exemplary flowchart of an algorithm for dividing an HTML page (as an example of an object) into a plurality of portions according to the present invention.

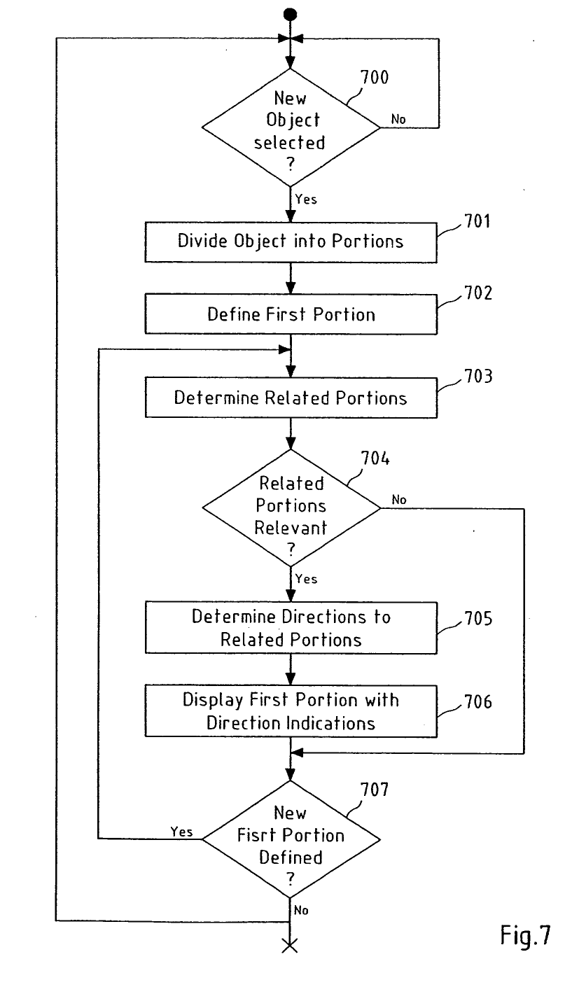

This algorithm may for instance be executed in step 701 of the flowchart of FIG. 7 (see description below).

In step 501 of the flowchart of FIG. 5, HTML elements of a web page are rendered and investigated in the order they appear in the HTML source code of said page. In said step 501, calculation of pixel values corresponding to said HTML elements is, for instance, performed as if an HTML page was shown in its original presentation size (original layout with 100% zoom factor). As a result, a maximum height and a maximum width in pixels of a number of rendered HTML elements is obtained.

In a step 502, it is then checked if the product of said maximum height and said maximum width is larger than a pre-defined threshold, for instance 100,000 pixels. If this is the case, a rectangular portion containing the HTML elements rendered in step 501 is formed in a step 503. Otherwise, the step 501 of rendering HTML elements is continued until the condition of step 502 is met.

In a step 504, it is then checked if a lower edge of said formed portion would vertically cut an element that cannot be divided (for instance an HTML <image>, or an HTML <object>). If this is the case, forming a portion according to step 503 is retried so that the last HTML element tried to be included at the last time in step 503 is not included anymore. This procedure is repeated until it leads to a lower edge of said portion that does not cut any HTML element. In addition to elements that cannot be cut, this procedure may also be applied to paragraphs (<p>, <div>), forms (<form>) and small tables (<table>).

This step may be performance-optimized by iterating first in bigger steps, and then element by element when new portion edges are almost found.

In a step 505, it is checked whether said formed portion would not have a straight top edge. If this is the case, the algorithm returns to step 503 and tries to form a new portion with a straight top edge. For example, if the first element for a portion is in the middle of a left table column, and the next element would be in the top of the right table column, the end of a portion should be created before the element that would make the top edge not straight.

If this is not the case, opportunities for combining portions are checked in a step 506.

For instance, if the width of a portion matches that of a previous portion, if these two portions are horizontally similarly positioned, and if the number of pixels of a combined portion obtained when these two portions are taken together is less than a threshold, for instance 150,000 pixels, then these two portions are combined.

Furthermore, if forming portions would create empty space below portions, this empty space may be combined with one or more portions above it, by vertically extending a portion above it by a required amount. In this special case, the empty space is not taken into account when checking a condition for re-portioning in a step 507, as will be explained below.

If this procedure of vertically extending portions to avoid empty spaces still leaves empty space between portions, vertical borders of portions are horizontally moved, so that empty space disappears (i.e. becomes included into portions). In this special case, too, empty space is not taken into account when checking a condition for re-portioning in a step 507.

Finally, in a step 507, it is checked if re-portioning of said formed portion is necessary, wherein in said re-portioning, the step 503 is again performed to form a new rectangular portion.

For instance, if the number of pixels of a formed portion gets bigger than a threshold, for instance 300,000 pixels, after its creation (for example because of a script adding content or arrival of big images), re-portioning is done for that portion and portions after it.

Similarly, if all content of a formed portion disappears after its creation (e.g. because of a script or external CSS), re-portioning is done for that portion and portions after it.

As a result of the algorithm of FIG. 5, a plurality of portions is output, which then may serve as a basis to determine the relations between said portions and the directions from one portion to another.

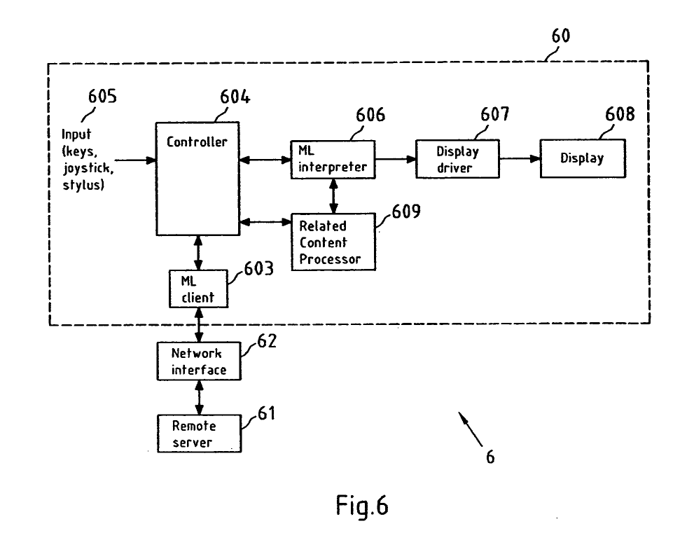

FIG. 6 depicts an exemplary set-up of a system 6 according to the present invention. The system 6 comprises a device 60, a remote server 61, for instance an internet server, and a network interface 62, wherein objects that are to be at least partially displayed on a display of said device 60 are transferred from said remote server 61 to said device 60 via the network interface 62.

The device 6, for instance a hand-held device such as a mobile phone, comprises the standard components required to implement a browser functionality: The controller 604 controls the function of the browser and receives input 605 from a viewer for example via the keyboard, touch-screen, mouse interaction, eye tracking or voice commands, e.g. a new Markup Language (ML) object (for instance a HTML page or a VRML object) that is to be loaded from the remote server 61. The ML client 603 provides services to the controller 604, in particular fetching of new ML objects via the network interface 62, which is connected to a remote server 61. If the device 6 is a hand-held device, said network interface 62 will usually be a wireless connection. The ML interpreter 606 is responsible for the display of ML objects (or portions thereof) on the display 608, which is controlled by the ML interpreter 606 via a display driver 607. The ML interpreter 606 parses the ML source code of the ML object and provides the display driver 607 with the corresponding results. In particular rendering of ML objects to fit the dimensions of the display 608 is performed by the ML interpreter 606 and display driver 607.

As an additional component, according to the present invention, a related content processor 609 is contained in the device 6, which supports the ML interpreter 606 and the controller 604 and in particular adds functionality to display an indication of second portions of an object that are not visible when a first portion of said object is displayed, wherein said second portions are related to said first portion. Said related content processor 609 may equally well be a functional component of said ML interpreter 606 and/or said controller 604. Said related content processor 609 may further be capable of deciding if content of second portions that have been decided to be related to said first portion is relevant content, and of determining a direction (and eventually a distance) from said first portion to said respective second portions. Furthermore, related content processor 609 may comprise functionality to divide an object into a plurality of portions, for instance via a sectioning algorithm, the outcome of which then serves as a basis for the determination of the portion that is currently displayed and for the determination of the direction from this portion to the related second portion.

In the system 6 of FIG. 6, it was assumed so far that the functionality to decide if the second portion is related to the first portion is provided by the related content processor 609. It should however be noted that this functionality can also be provided by components in the remote server 61 or by network elements, for instance, if said device 60 is a mobile phone, said network interface 62 also comprises components of a core network of a mobile radio communications system that operates said mobile phone, and said network elements then may be parts of said mobile radio communications system. It may for instance be advantageous to perform the division of objects into a plurality of portions and the decision on which of said portions are related in said network elements in order to unburden the processing in the mobile phone. Said relations between said portions then may for instance be stored in a data format and transferred to said mobile phone, which then only has to display the first portion and to display an indication of relevant second portions based on the information in said data format, which may for instance comprise the direction from said first portion to said second portion.

FIG. 7 depicts a flowchart of an embodiment of the present invention. The steps of this flowchart may for instance be performed in the related content processor 609, the ML interpreter 606 and/or the controller 604 of the system 6 in FIG. 6, and/or, as discussed before, also partially in said remote server 61 and/or network interface 62.

In a first step 700, it is checked if a new object, for instance a web page, has been selected by a viewer. If this is not the case, step 700 is repeated until a new object is selected. If this is the case, in a step 701, said new object is divided into a plurality of portions. In a further step 702, a first portion out of said plurality of portions is defined. This may for instance be a default portion, for instance the left upper portion of the new object, or a portion of said new object that has been explicitly selected by a viewer for displaying on a display. In a step 703, second portions of said new object that are related to said first portion are then determined. This may for instance comprise scanning all portions of said object, and deciding if said respective portions are related to said first portion or not. In a step 704, it is then checked if any of the obtained related second portions contains relevant content, for instance if it is non-empty or has a certain size or contains a certain amount of pixels. If this is the case, in a step 705, directions from said first portion to said related and relevant second portions are determined. In a step 706, then the first portion, together with the determined directions towards all relevant and related second portions, is displayed. Finally, in a step 707, it is checked if a new first portion has been defined, for instance by selection of a viewer (this step is also performed if it is decided in step 704 that none of the related second portions contains relevant content). If this is the case, the procedure jumps back to step 703. Otherwise, the procedure jumps back to step 700.

The invention has been described above by means of preferred embodiments. It should be noted that there are alternative ways and variations which will be evident to a skilled person in the art and can be implemented without deviating from the scope and spirit of the appended claims. In particular, the present invention is not limited to deployment in the context of 2D and 3D documents (like HTML and VRML documents), but can equally well be used with different objects, such as for instance 2D and 3D application views, i.e. displayed representations of data of an application. In application views, data is not displayed in its actual form, but as a representation thereof, which may for instance be a name, icon, thumbnail, or any other representation. For instance, an application view of a data base may be a file browser user interface that displays a structure of names and icons representing documents and folders in said data base, an application view of an image album may be a thumbnail view of said images, and an application view of a calendar may be calendar sheets that represent the time schedules of respective days. Equally well, said object may be a combination of said application views and said data they represent, for instance, a grid of thumbnails may and an image may form said object.

1. A method for displaying portions of an object, said method comprising:
displaying at least a first portion of an object;
deciding if a second portion of said object, which second portion is not visible during said displaying of said first portion, is related to said first portion; and
displaying an indication of said second portion, if it is decided that said second portion is related to said first portion.

2. The method according to claim 1, wherein a direction from said first portion to said second portion is displayed as said indication of said second portion.

3. The method according to claim 2, wherein said direction is substantially a horizontal direction.

4. The method according to claim 2, wherein said object is a three-dimensional object, and wherein said direction is a direction in a three-dimensional space.

5. The method according to claim 2, wherein said direction is represented by a separate graphical indicator.

6. The method according to claim 2, wherein said direction is indicated by altering the appearance of said first portion.

7. The method according to claim 2, wherein said indication contains information of said second portion.

8. The method according to claim 2, wherein said indication contains information about a distance to said second portion.

9. The method according to claim 1, wherein said indication is only displayed for a limited duration of time.

10. The method according to claim 2, further comprising:
dividing said object into a plurality of portions of said object;
determining which of said portions is said first portion that is displayed; and
determining said direction from said first portion towards said second portion.

11. The method according to claim 10, wherein a sectioning algorithm is used to divide said object into said plurality of portions of said object.

12. The method according to claim 1, further comprising:
deciding if said second portion contains relevant content,
wherein said indication of said second portion is only displayed if a first condition, that said second portion is related to said first portion, and a second condition, that said second portion contains relevant content, are both true.

13. The method according to claim 12, wherein said second portion is considered to contain relevant content in dependence on its size and/or the type and/or the amount of its content.

14. The method according to claim 12, wherein said step of deciding if said second portion of said object is related to said first portion is based on relations of portions of said object that have been defined by a creator of said object.

15. The method according to claim 1, wherein said first portion is displayed in a presentation mode in which said object has been at least partially rendered.

16. The method according to claim 1, wherein said first portion is displayed in a presentation mode in which an original layout of said object has at least partially been preserved.

17. The method according to claim 1, wherein said object can be displayed in a first presentation mode, wherein, upon viewer interaction, at least said first portion is displayed in a second presentation mode, and wherein a size of said first portion in said second presentation mode is substantially larger than its size in said first presentation mode.

18. The method according to claim 1, wherein said first portion is displayed on a display of a hand-held electronic device.

19. The method according to claim 1, wherein said object is a two-dimensional object.

20. The method according to claim 1, wherein said object has a page structure.

21. The method according to claim 1, wherein said object is a three-dimensional object.

22. A computer program with instructions operable to cause a processor to perform the method steps of claim 1.

23. A computer program product comprising a computer program with instructions operable to cause a processor to perform the method steps of claim 1.

24. A device for displaying portions of an object, said device comprising:
means arranged for displaying at least a first portion of an object;
means arranged for deciding if a second portion of said object, which second portion is not visible during said displaying of said first portion, is related to said first portion; and
means arranged for displaying an indication of said second portion in dependence on said decision if said second portion is related to said first portion.

25. A system for displaying portions of an object, said system comprising a first device and a second device, wherein said first device comprises means arranged for displaying at least a first portion of an object;
wherein said second device comprises means arranged for deciding if a second portion of said object, which second portion is not visible during said displaying of said first portion, is related to said first portion; and
wherein said first device further comprises means arranged for displaying an indication of said second portion in dependence on said decision if said second portion is related to said first portion.
